(19) United States
(12) Patent Application Publication
(10) Pub. No.: US 2017/0092913 A1
(43) Pub. Date: Mar. 30, 2017

(54) FILM PRODUCTION METHOD AND FILM PRODUCTION DEVICE

(71) Applicant: Sumitomo Chemical Company, Limited, Tokyo (JP)

(72) Inventors: Rikuri UEJIMA, Niihama-shi (JP); Akihiko SHIN, Daegu (KR)

(21) Appl. No.: 15/280,102

(22) Filed: Sep. 29, 2016

(30) Foreign Application Priority Data
Sep. 30, 2015 (JP) 2015-194107
Jun. 14, 2016 (JP) 2016-117835

(51) Int. Cl. H01M 2/14; H01M 10/0525; B05D 1/28; B05D 1/02; B05D 1/00

(52) U.S. Cl. CPC H01M 2/145; B05D 1/02; B05D 1/005; B05D 1/28; H01M 10/0525

(57) ABSTRACT

An unnecessary substance is removed from a film which is being washed, while problems that occur to the film being washed are resolved. A method for washing a film includes the steps of: (a) transferring a heat-resistant separator in a lengthwise direction so that the heat-resistant separator passes through washing water in a washing tank; and (b) upwardly or downwardly discharging the washing water which has been guided into the washing tank through an inner wall of the washing tank, which inner wall faces a widthwise end part of the heat-resistant separator.

This Nonprovisional application claims priority under 35 U.S.C. §119 on Patent Application No. 2015-194107 filed in Japan on Sep. 30, 2015 and on Patent Application No. 2016-117835 filed in Japan on Jun. 14, 2016, the entire contents of which are hereby incorporated by reference.

### TECHNICAL FIELD

The present invention relates to a method and a device for producing a film such as a separator for use in a battery such as a lithium ion secondary battery.

### BACKGROUND ART

A lithium-ion secondary battery includes therein a cathode and an anode which are separated by a separator that is in a form of film and is porous. A process of producing the separator includes a washing step of removing an unnecessary substance from the film which has been prepared in advance.

For example, if not limited to a separator, techniques disclosed in Patent Literatures 1 and 2 are known as techniques to wash a sheet or a film. Patent Literature 1 discloses a washing tank including two tanks for roughly and thoroughly washing a heat-sealing multilayer sheet in sequence. Patent Literature 2 discloses a washing section having a plurality of stages for soak-washing and spray-washing an optical plastic film in sequence.

### CITATION LIST

### Patent Literatures

Patent Literature 1

Japanese Patent Application Publication, Tokukai, No. 2001-170933 (Publication Date: Jun. 26, 2001)
Patent Literature 2

Japanese Patent Application Publication, Tokukai, No. 2007-105662 (Publication Date: Apr. 26, 2007)

### SUMMARY OF INVENTION

### Technical Problem

A porous separator and an intermediate product film thereof have mechanical strength which is lower than that of a simple non-porous film. This tends to cause problems such as folds, creases, and tears during the process of producing the porous separator and the intermediate product film, particularly during a washing step. However, neither Patent Literature 1 nor Patent Literature 2 addresses these problems. It is an object of the present invention to remove an unnecessary substance from a film which is being washed, while problems that occur to the film being washed are resolved.

### Solution to Problem

In order to attain the object, a film production method of the present invention, is a method for producing a film, including the steps of: (a) transferring a film in a lengthwise direction so that the film passes through a liquid in a liquid tank; and (b) upwardly or downwardly discharging the liquid which has been guided into the liquid tank through an inner wall of the liquid tank, which inner wall faces a widthwise end part of the film.

Another film production method of the present invention is method for producing a film, including the steps of: (a) transferring a film in a lengthwise direction so that the film passes through a liquid in a liquid tank; and (b) upwardly discharging the liquid which has been guided into the liquid tank through a part of a bottom surface of the liquid tank, the part being located closer to one or the other one of two inner walls of the liquid tank, which two inner walls face respective widthwise end parts of the film.

A film production device of the present invention includes: a liquid tank; a transferring device for transferring a film in a lengthwise direction so that the film passes through a liquid in the liquid tank; and a discharging section for upwardly or downwardly discharging the liquid which has been guided into the liquid tank through an inner wall of the liquid tank, which inner wall faces a widthwise end part of the film.

Another film production device of the present invention includes: a liquid tank; a transferring device for transferring a film in a lengthwise direction so that the film passes through a liquid in the liquid tank; and a discharging section for upwardly or downwardly discharging the liquid which has been guided into the liquid tank through a part of a bottom surface of the liquid tank, the part being located closer to one or the other one of two inner walls of the liquid tank, which two inner walls face respective widthwise end parts of the film.

### Advantageous Effects of Invention

The present invention makes it possible to produce a film on which a remaining remove-target substance is restricted, while a problem that occurs to the film is inhibited.

### BRIEF DESCRIPTION OF DRAWINGS

FIG. 1 is a schematic view illustrating a cross sectional configuration of a lithium-ion secondary battery.

FIG. 2 is a schematic view illustrating a detailed configuration of the lithium-ion secondary battery illustrated in FIG. 1.

FIG. 3 is a schematic view illustrating another configuration of the lithium-ion secondary battery illustrated in FIG. 1.

FIG. 4 is a cross-sectional view illustrating a configuration of a washing device used in a washing method in accordance with Embodiment 1.

FIG. 5 is a cross-sectional view illustrating a peripheral configuration of a guide roller used in a washing method in accordance with Embodiment 2.

FIG. 6 is a cross-sectional view illustrating a peripheral configuration of a roller used in a washing method in accordance with Embodiment 3.

FIG. 7 is a set of a side cross-sectional view, a plan view, and a front cross-sectional view which illustrate configurations for circulating washing water in a washing tank in accordance with Embodiment 4.

FIG. 8 is a set of front cross-sectional views and a parallel cross-sectional view which illustrate variations of a detour illustrated in FIG. 7.

FIG. 9 is a set of side cross-sectional views each illustrating a configuration of a pipe provided between the washing device and a washing tank illustrated in FIG. 4.

FIG. 10 is a set of a front cross-sectional view and plan views which illustrate other configurations of discharging sections of washing tank illustrated in FIG. 7.

FIG. 11 is a set of a side cross-sectional view, a plan view, and a front cross-sectional view which illustrate configurations for circulating washing water in a washing tank in accordance with Embodiment 5.

### DESCRIPTION OF EMBODIMENTS

### Basic Configuration

The description below deals sequentially with a lithium-ion secondary battery, a separator, a heat-resistant separator, and a method for producing a heat-resistant separator.

(Lithium Ion Secondary Battery)

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

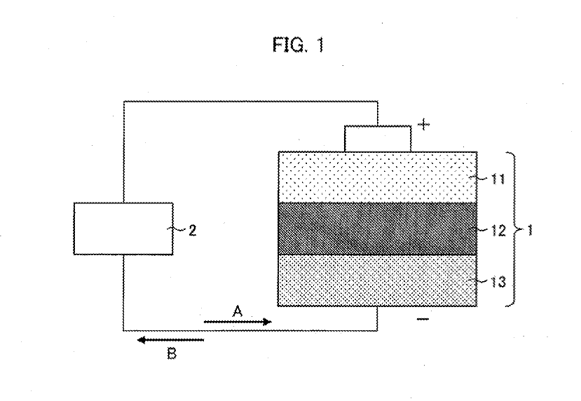

FIG. 1 is a diagram schematically illustrating a cross sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

(Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

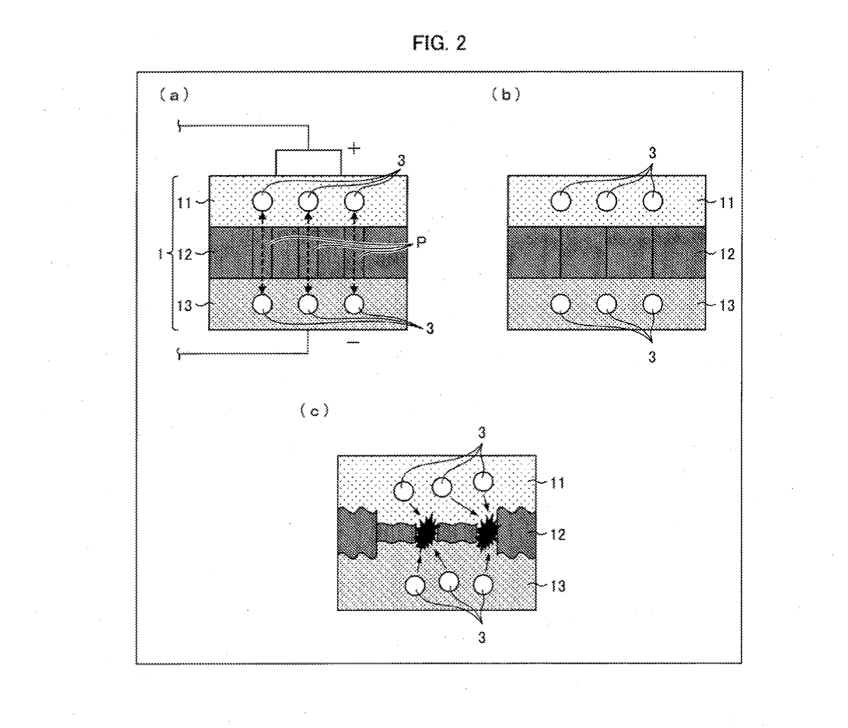

FIG. 2 provides diagrams each schematically illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

(Heat-Resistant Separator)

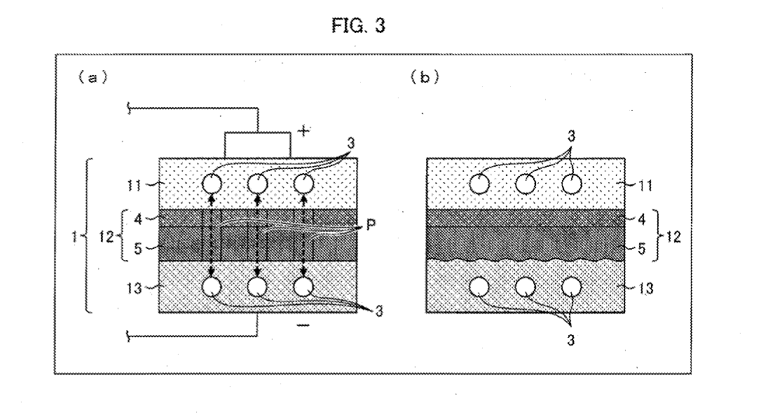

FIG. 3 provides diagrams schematically illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat-resistant separator that includes a porous film 5 and a heat-resistant layer 4. The heat-resistant layer 4 is laminated on a surface of the porous film. 5 which surface is on a cathode 11 side. Note that the heat-resistant layer 4 can alternatively be laminated on a surface of the porous film 5 which surface is on an anode 13 side, or both surfaces of the porous film 5. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the porous film 5 melts or softens, the shape of the porous film 5 is maintained because the heat-resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

(Steps of Producing Separator, Heat-Resistant Separator)

How to produce the separator and heat-resistant separator of the lithium-ion secondary battery 1 is not specifically limited, and the separator and heat-resistant separator can be produced by a well-known method. The following discussion assumes a case where the porous film 5 contains polyethylene as a main material. However, even in a case where the porous film 5 contains another material, similar steps can still be applied to production of the separator 12 (heat-resistant separator).

For example, it is possible to employ a method including the steps of first forming a film by adding an inorganic filler or plasticizer to a thermoplastic resin, and then washing the film with an appropriate solvent to remove the inorganic filler or plasticizer. For example, in a case where the porous film 5 is a polyolefin separator made of a polyethylene resin containing ultrahigh molecular weight polyethylene, it is possible to produce the separator 12 by the following method.

This method includes (1) a kneading step of obtaining a polyethylene resin composition by kneading an ultrahigh molecular weight polyethylene and an inorganic filler (for example, calcium carbonate or silica) or plasticizer (for example, a low molecular weight polyolefin or liquid paraffin), (2) a rolling step of forming a film with the polyethylene resin composition, (3) a removal step of removing the inorganic filler or plasticizer from the film obtained in the step (2), and (4) a stretching step of obtaining the porous film 5 by stretching the film obtained in the step (3). The step (4) may alternatively be carried out between the steps (2) and (3).

In the removal step, many fine pores are provided in the film. The fine pores of the film stretched in the stretching step become the above-described pores P. The porous film 5 formed as a result is a polyethylene microporous film having a prescribed thickness and a prescribed air permeability (that is, a separator 12 not having a heat-resistant layer).

Note that in the kneading step, 100 parts by weight of the ultrahigh molecular weight polyethylene, 5 parts by weight to 200 parts by weight of a low-molecular weight polyolefin having a weight-average molecular weight of not more than 10000, and 100 parts by weight to 400 parts by weight of the inorganic filler can be kneaded.

Thereafter, in a coating step, the heat-resistant layer 4 is formed on a surface of the porous film 5. For example, on the porous film 5, an aramid/NMP (N-methylpyrrolidone) solution (coating solution) is applied (applying step) and solidified (solidifying step), and thereby, the heat-resistant layer 4 that is an aramid heat-resistant layer is formed. The heat-resistant layer 4 can be provided on only one surface or both surfaces of the porous film 5.

In the coating step, a polyvinylidene fluoride/dimethylacetamide solution (coating solution) may be applied (applying step) to a surface of the porous film 5 and solidified (solidifying step) to form an adhesive layer on the surface of the porous film 5. The adhesive layer can be provided on only one surface or both surfaces of the porous film 5.

In this specification, a layer, which has a function such as adhesiveness to an electrode or heat resistance to a temperature equal to or higher than a melting point of polyolefin, is referred to as “functional layer”.

A method for coating the porous film 5 with a coating solution is not specifically limited as long as uniform wet coating can be performed by the method. The method can be a conventionally well-known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film and/or a solid-content concentration in the coating solution.

It is possible to use a resin film, a metal belt, a drum or the like as a support with which the porous film 5 is fixed or transferred in coating.

As described above, it is possible to produce the separator 12 (heat-resistant separator) in which the heat-resistant layer 4 is laminated on the porous film 5. Thus produced separator is wound on a cylindrical core. Note that a subject to be produced by the above production method is not limited to the heat-resistant separator. The above production method does not necessarily include the coating step. In a case where the method includes no coating step, the subject to be produced is a separator having no heat-resistant layer.

### Embodiment 11

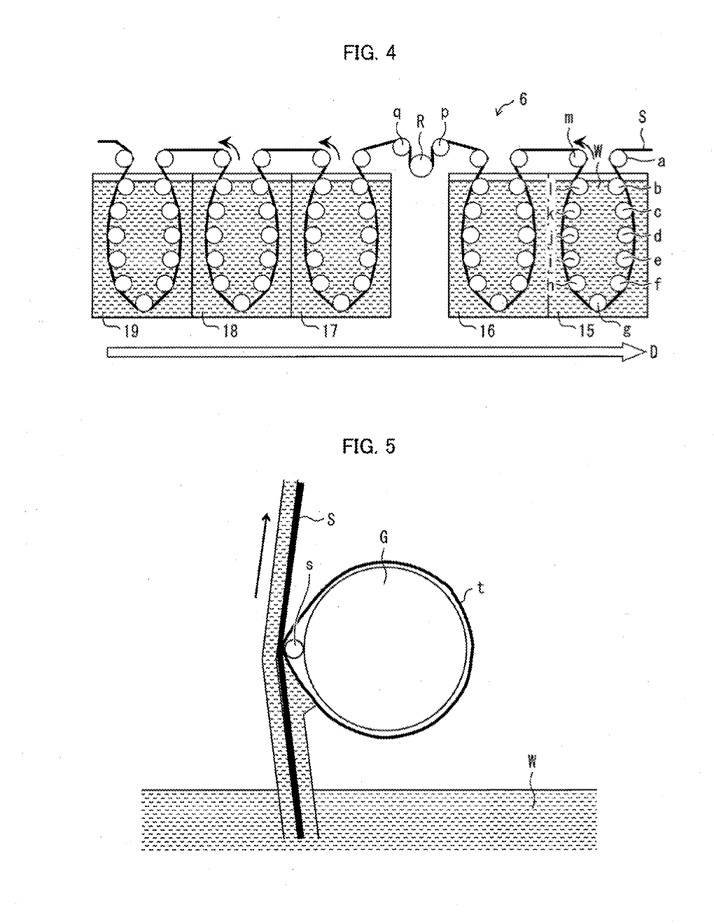

The following description will discuss Embodiment 1 of the present invention, with reference to FIG. 4.

In Embodiment 1, a washing method for washing a heat-resistant separator, which is a long and porous battery separator, is described. A heat-resistant layer of the heat-resistant separator is formed by applying an aramid/NMP (N-methylpyrrolidone) solution (coating solution) to a porous film. In this case, NMP (remove-target substance) which is a solvent sinks into pores of the porous film.

An air permeability of the heat-resistant separator in which NMP remains in the pores is lower than that of a heat-resistant separator in which no NMP remains in pores. As the air permeability is lower, movement of lithium ions of a lithium-ion secondary battery including the heat-resistant separator is further interfered with, and consequently output of the lithium-ion secondary battery decreases. Therefore, it is preferable to wash the heat-resistant separator so that NMP does not remain in the pores of the heat-resistant separator.

<<Configuration in which Heat-Resistant Separator is Washed with Use of Multi-Stage Washing Tank>>

(Washing Tank)

FIG. 4 is a cross-sectional view illustrating a configuration of a washing device 6 used in a washing method in accordance with Embodiment 1.

As illustrated in FIG. 4, the washing device 6 includes washing tanks 15 through 19. Each of the washing tanks 15 through 19 is filled with washing water W (liquid).

Further, the washing device 6 includes a plurality of rollers which are rotatable for transferring a heat-resistant separator S. Among the plurality of rollers, rollers a through m are rollers for transferring the heat-resistant separator S which is to be washed in the washing tank 15.

The heat-resistant separator S which has been transferred from a step (for example, coating step) which is upstream from a washing step passes through, via the rollers a through m, the washing water W (hereinafter referred to as “water”) filling the washing tank 15. The rollers a through m (transferring roller) define a transferring path of the heat-resistant separator S in the washing tank 15. In the washing tanks 16 through 19, the heat-resistant separator S is washed in a manner similar to that in the washing tank 15.

(Driving Roller)

The washing device 6 further includes a driving roller R and auxiliary rollers p and q for applying driving force to the heat-resistant separator S between washing tanks. The auxiliary rollers p and q define an angle (so-called “holding angle”) at which the heat-resistant separator S makes contact with the driving roller R. Although the driving roller R and the auxiliary rollers p and q can be provided in water, the driving roller R and the auxiliary rollers p and q are preferably provided between washing tanks as illustrated in FIG. 4, because it is not necessary to give a water-proof treatment to the rollers.

As described above, driving force for transferring the heat-resistant separator S is applied between a position of the roller a for the washing tank 15 (first washing tank) and a position of a roller (corresponding to the roller n) for the washing tank 19 (second washing tank). Here, the “position of the roller a for the washing tank 15” is a position at which the heat-resistant separator S is brought into the washing tank 15. The “position of a roller (corresponding to the roller m) for the washing tank 19” is a position at which the heat-resistant separator S is taken out from the washing tank 19.

The driving force is preferably applied to the heat-resistant separator S between (i) a position which is of a roller (corresponding to the roller 1) for the washing tank 16 (first washing tank) and is on a washing tank 17 side and (ii) a position which is of a roller (corresponding to the roller b) for the washing tank 17 (second washing tank) and is on a washing tank 16 side. Here, the “position which is of a roller (corresponding to the roller 1) for the washing tank 16 and is on a washing tank 17 side” is a position at which the heat-resistant separator S is taken out from water in the washing tank 16. The “position which is of a roller (corresponding to the roller b) for the washing tank 17 and is on a washing tank 16 side” is a position at which the heat-resistant separator S is brought into the water in the washing tank 17.

<<Operation in which Heat-Resistant Separator is Washed with Use of Multi-Stage Washing Tank>>

The washing method in accordance with Embodiment 1 includes a step of transferring the heat-resistant separator S in a lengthwise direction of the heat-resistant separator S and a step of washing the heat-resistant separator S, which is being transferred, by causing the heat-resistant separator S to sequentially pass through washing waters W in the washing tanks 15 through 19. As such, the heat-resistant separator S is sequentially transferred from an upstream washing tank (first washing tank) to a downstream washing tank (second washing tank). Here, unless otherwise noted, the terms “upstream” and “downstream” respectively mean an upstream side and a downstream side in a transferring direction of a separator.

After washing in the washing tanks 15 through 19 has finished, the beat-resistant separator S is transferred to a step (for example, drying step) downstream from the washing step.

<<Effect of Embodiment 1>>

(Washing by Diffusion)

In a case where the heat-resistant separator S passes through the washing water W, NMP diffuses from the pores of the heat-resistant separator S to the water. Here, a diffusion amount of NMP becomes larger as a concentration of NMP in the washing water W is lower.

The heat-resistant separator S is washed sequentially in the washing tanks 15 through 19, and therefore a concentration of NMP in washing water W is lower in a downstream washing tank than in an upstream washing tank. That is, NMP is diffused in stages, and it is therefore possible to reliably remove NMP from the pores.

(Direction in which Washing Water Flows)

As illustrated in FIG. 4, washing water W can flow in a direction D from the downstream washing tank 19 to the upstream washing tank 15 in the separator transferring direction. From this, for example, partition walls each provided between the washing tanks 15 through 19 can have heights which become lower from the downstream side to the upstream side in the separator transferring direction. In this case, in the washing method in accordance with Embodiment 1, washing water W is supplied to the downstream washing tank and the washing water W in the downstream washing tank is then supplied to an upstream washing tank, and thus the washing method further includes a step of renewing the washing water W in each of the washing tanks. From the upstream washing tank 15, part of the washing water W flows out. With the configuration, it is possible to cause an NMP concentration in washing water W in the downstream washing tank in the separator transferring direction to be lower than an NMP concentration in washing water W in the upstream washing tank, while efficiently using the washing water W.

(Efficient Washing)

By diffusing NMP in stages, it is possible to efficiently remove NMP, as compared with washing in only one washing tank. It is therefore possible to shorten a transferring distance of the heat-resistant separator S during washing. From this, it is possible to wash the heat-resistant separator S whose mechanical strength is lower than that of a non-porous film while inhibiting a fold, a crease, a tear, and meandering.

### Other Configuration

### Circulation of Washing Water

As a width of the heat-resistant separator S becomes broader, productivity increases. Therefore, the width (i.e., a width in a direction perpendicular to the sheet on which FIG. 4 is illustrated) of the heat-resistant separator S is often set to be a width similar to that of the washing tanks 15 through 19. Moreover, the width of the washing tanks 15 through 19 is designed in accordance with the width of the heat-resistant separator S.

In a case where the width of the heat-resistant separator S is broadened and a gap between an end part of the heat-resistant separator S and the washing tanks 15 through 19 becomes smaller, washing water W in each of the washing tanks 15 through 19 is to be separated into one surface side (i.e., center side of washing tank) of the heat-resistant separator S and another surface side (i.e., both end sides of washing tank (right and left sides of washing tank in FIG. 4)) of the heat-resistant separator S.

In the washing in the washing tanks 15 through 19, the washing water W is often supplied/drained by overflow between the washing tanks 15 through 19. In this case, washing water W on the one surface side of the heat-resistant separator S may be supplied/drained, whereas washing water W on the another surface side of the heat-resistant separator S may remain.

In view of this, the washing method in accordance with Embodiment 1 can include a step of circulating washing water W so as to facilitate interchanging of washing waters W between the one surface side and the another surface side of the heat-resistant separator S in at least one of the washing tanks 15 through 19. In this case, the washing device 6 can further include a circulating device which is provided in the at least one of the washing tanks 15 through 19 and has an inlet and an outlet for washing water W.

This makes it possible to further uniformize an NMP concentration in washing water W in one washing tank, and it is therefore possible to facilitate efficient removal of NMP

(Washing Water)

The washing water W is not limited to water, provided that the washing water W is a washing liquid which can remove NMP from the heat-resistant separator S.

Moreover, the washing water W can contain a cleaning agent such as a surfactant, an acid (e.g., hydrochloric acid), or a base. A temperature of the washing water W is preferably 120° C. or lower. With this temperature condition, heat shrinkage of the heat-resistant separator S is less likely to occur. The temperature of the washing water W is more preferably 20° C. or higher and 100° C. or lower.

(Method for Producing Polyolefin Separator)

The above washing method for washing the heat-resistant separator S is applicable to a washing method for washing a separator (polyolefin separator) having no heat-resistant layer.

The separator is formed by stretching a film-shaped polyolefin resin composition which has been obtained by kneading high molecular weight polyolefin such as ultrahigh molecular weight polyethylene and an inorganic filler or a plasticizer. Further, the remove-target substance such as the inorganic filler or the plasticizer is washed, and thus pores of the separator are formed.

An air permeability of a separator in which the remove-target substance has not been washed and remains in pores is lower than an air permeability of a separator in which the remove-target substance does not remain in pores. As the air permeability is lower, movement of lithium ions of a lithium-ion secondary battery including a separator is further interfered with, and consequently output of the lithium-ion secondary battery decreases. Therefore, it is preferable to wash the separator so that the remove-target substance does not remain in the pores of the separator.

A washing liquid for washing a separator containing an inorganic filler is not limited, provided that the washing liquid can remove the inorganic filler from the separator. The washing liquid is preferably an aqueous solution containing an acid or a base.

A washing liquid for washing a separator containing a plasticizer is not limited, provided that the washing liquid can remove the plasticizer from the separator. The washing liquid is preferably an organic solvent such as dichloromethane.

The outline of the above is as follows: that is, the washing method for washing a film-shaped polyolefin resin composition (film) includes the steps of (i) transferring a film, which is long and is an intermediate product of the separator, in a lengthwise direction of the film and (ii) washing the film by causing the film, which is being transferred, to sequentially pass through washing water W in the respective washing tanks 15 through 19.

As such, in FIG. 4, the heat-resistant separator S can serve as a film which is an intermediate product of a separator. Moreover, the washing water W can be an aqueous solution which contains an acid or a base.

The method for producing a polyolefin separator includes (i) a forming step of forming a film which is long, is an intermediate product of a long and porous separator, and contains polyolefin as a main component and (ii) the steps of the above film washing method which steps are carried out after the forming step.

(Method for Producing Laminated Separator)

The present invention encompasses a method for producing a heat-resistant separator S, which is a laminated separator, with use of the washing method for washing the heat-resistant separator S. Here, the heat-resistant separator S is a laminated separator including a porous film 5 (base material) and a heat-resistant layer 4 (functional layer) which is laminated on the porous film 5, as illustrated in FIG. 3. This producing method includes a forming step of forming a long and porous heat-resistant separator 8 and the steps in the above described separator washing method which steps are carried out after the forming step.

In order to laminate the heat-resistant layer 4, the “forming step” includes an applying step of applying, to the porous film 5, NMP (liquid substance) containing aramid resin (substance) for constituting the heat-resistant layer 4 and a solidifying step of solidifying the aramid resin after the applying step.

The “steps” mean the steps of (i) transferring the heat-resistant separator S in the lengthwise direction thereof and (ii) washing the heat-resistant separator S by causing the heat-resistant separator S, which is being transferred, to sequentially pass through water in the respective washing tanks 15 through 19.

From this, it is possible to produce the laminated separator which hardly contains NMP and in which problems are inhibited. Note that the heat-resistant layer can be the early described adhesive layer.

### Embodiment 2

The following description will discuss Embodiment 2 of the present invention with reference to FIG. 5. For convenience of explanation, identical reference numerals are given to constituent members having functions identical with those of the constituent members described in Embodiment 1, and descriptions of such constituent members are omitted here. This applies to other embodiments described below.

<<Configuration in which Washing Water is Removed from Heat-Resistant Separator>>

FIG. 5 is a cross-sectional view illustrating a peripheral configuration of a guide roll G used in a washing method of the Embodiment 2.

As illustrated in FIG. 5, a washing device 6 further includes a guide roll G, a Teflon bar s, and a Teflon tube t. Note that “Teflon” is a registered trademark.

The guide roll G (i) is fixed to a transferring path on which the heat-resistant separator S is transferred, (ii) does not rotate, and (iii) is provided between rollers l and m for a washing tank 15.

The Teflon bar s extends along lengthwise directions of the guide roll G, and is provided on a surface of the guide roll G.

The Teflon tube t confines the guide roll G and the Teflon bar s so as to wrap the guide roll G and the Teflon bar s.

Note that the guide roll G can be provided for any of the washing tanks 16 through 19. Moreover, the washing device 6 can include plural sets of the guide roll G, the Teflon bar s, and the Teflon tube t.

<<Operation in which Washing Water is Removed from Heat-Resistant Separator>>

The washing method of the Embodiment 2 includes, in addition to the steps in the washing method in accordance with Embodiment 1, the step of removing washing water W from the heat-resistant separator S between an upstream washing tank and a downstream washing tank.

In a case where the heat-resistant separator S is pulled up from the water, part of washing water W in the upstream washing tank is, by surface tension, brought to the downstream washing tank along the surface of the heat-resistant separator S. In view of this, the washing water W which is to be brought to the downstream washing tank is scraped off from the heat-resistant separator S.

The Teflon bar s which is provided on the surface of the guide roll G that is fixed serves to form a protrusion on a surface of the Teflon tube t. The protrusion is brought into contact with the heat-resistant separator S so as to softly rub the heat-resistant separator S, and thus scrapes washing water W off from the heat-resistant separator S.

In a case where the heat-resistant separator S is a polyethylene porous film which has one surface coated with a heat-resistant aramid layer, it is preferable to press the protrusion formed on the surface of the Teflon tube t against another surface of the porous film which another surface is not coated with the heat-resistant layer. This makes it possible to prevent detachment of the heat-resistant layer.

<<Effect of Embodiment 2>>

With the configuration in accordance with Embodiment 2, it is possible to reduce washing water W which is to be brought from the upstream washing tank to the downstream washing tank. It is therefore possible to reliably control an NMP concentration in washing water W in the downstream washing tank to be lower than that in washing water W in the upstream washing tank. This leads to reliable removal of NMP from the pores of the heat-resistant separator S.

### Embodiment 3

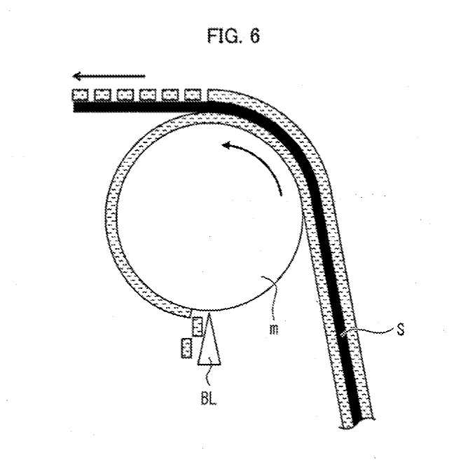

The following description will discuss Embodiment 3 of the present invention with reference to FIG. 6.

<<Configuration in which Washing Water is Removed from Transferring Roller for Transferring Heat-Resistant Separator>>

FIG. 6 is a cross-sectional view illustrating a peripheral configuration of a roller m used in a washing method in accordance with Embodiment 3.

As illustrated in FIG. 6, a washing device 6 further includes a scrape-off bar BL.

The scrape-off bar BL is a blade for scraping off, by surface tension, washing water W which is transferred along the roller m.

A slight gap is provided between the roller m and the scrape-off bar BL. This prevents damage on a surface of the roller m and abrasion of the scrape-off bar BL each from occurring.

<<Operation in which Washing Water is Removed from Transferring Roller for Transferring Heat-Resistant Separator>>

The washing method in accordance with Embodiment 3 includes, in addition to the steps in the washing method in accordance with Embodiment 1, the step of removing washing water W from the roller m for transferring the heat-resistant separator S between an upstream washing tank and a downstream washing tank.

When the heat-resistant separator S is transferred, part of washing water W is, by surface tension, brought to the downstream washing tank along a surface of the heat-resistant separator S. Further, the part of washing water W which is brought to the downstream washing tank is transferred along the roller m by surface tension. Then, the washing water W transferred along the roller m by surface tension is scraped off from the roller m.

<<Effect of Embodiment 3>>

With the configuration in accordance with Embodiment 3, it is possible to reduce an amount of washing water W which is brought from the upstream washing tank to the downstream washing tank. It is therefore possible to reliably control an NMP concentration in washing water W in the downstream washing tank to be lower than that in washing water W in the upstream washing tank. This leads to reliable removal of NMP from the pores of the heat-resistant separator S.

### Variation 1

The washing device 6 can include all the guide roll G, the Teflon bar s, the Teflon tube t (which are illustrated in FIG. 5), and the scrape-off bar BL (which is illustrated in FIG. 6).

A washing method of this variation includes, in addition to the steps in the washing method in accordance with Embodiment 1, the steps of removing washing water W from the heat-resistant separator S between the upstream washing tank and the downstream washing tank and removing washing water W from the roller m for transferring the heat-resistant separator S between the upstream washing tank and the downstream washing tank.

With the configuration, it is possible to further reduce an amount of washing water W which is brought from the upstream washing tank to the downstream washing tank. It is therefore possible to reliably control an NMP concentration in washing water W in the downstream washing tank to be lower than that in washing water W in the upstream washing tank. This leads to further reliable removal of NMP from the pores of the heat-resistant separator S.

### Variation 2

The washing device 6 can include one washing tank. From this, the present invention encompasses the following aspect:

A separator washing method in accordance with a first aspect of the present invention is a method for washing a battery separator which is long and porous, the separator washing method including the steps of: transferring the battery separator in a lengthwise direction of the battery separator; washing the battery separator by causing the battery separator, which is being transferred, to pass through a washing liquid in a washing tank; and removing the washing liquid from the battery separator between a position at which the battery separator is brought into the washing tank and a position, at which the battery separator is taken out from the washing tank.

The first aspect is an aspect in which, for example, washing water W is removed from the heat-resistant separator S (battery separator) by the guide roll c, the Teflon bar s, and the Teflon tube t as illustrated in FIG. 5, in at least one of the washing tanks 15 through 19 which are illustrated in FIG. 4. According to the first aspect, it is possible to reduce an amount of the washing liquid which is to be brought from the washing step to another step.

A separator washing method in accordance with a second aspect of the present invention is a method for washing a battery separator which is long and porous, the separator washing method including the steps of: transferring the battery separator in a lengthwise direction of the battery separator; washing the battery separator by causing the battery separator, which is being transferred, to pass through a washing liquid in a washing tank; and removing the washing liquid from a transferring roller for transferring the battery separator between a position at which the battery separator is brought into the washing tank and a position at which the battery separator is taken out from the washing tank.

The second aspect is an aspect in which, for example, washing water W is removed from the roller m (transferring roller) for transferring the heat-resistant separator S (battery separator) by the scrape-off bar BL as illustrated in FIG. 6, in at least one of the washing tanks 15 through 19 which are illustrated in FIG. 4. According to the second aspect, it is possible to reduce an amount of the washing liquid which is to be brought from the washing step to another step.

A separator washing method in accordance with a third aspect of the present invention is a method for washing a battery separator which is long and porous, the separator washing method including the steps of: transferring the battery separator in a lengthwise direction of the battery separator; washing the battery separator by causing the battery separator, which is being transferred, to pass through a washing liquid in a washing tank; and circulating the washing liquid in the washing tank so as to facilitate interchanging of washing liquids between one surface side and another surface side of the battery separator.

The third aspect is an aspect in which, for example, washing water W (washing liquid) is circulated so as to facilitate interchanging of washing waters W between the one surface side and another surface side of the heat-resistant separator S (battery separator) in at least one of the washing tanks 15 through 19 which are illustrated in FIG. 4. According to the third aspect, it is possible to further uniformize a concentration of the remove-target substance in the washing liquid in the washing tank, and it is therefore possible to facilitate efficient removal of the remove-target substance.

A separator washing method in accordance with a fourth aspect of the present invention is a method for washing a battery separator which is long and porous, the separator washing method including the steps of: transferring the battery separator in a lengthwise direction of the battery separator; and washing the battery separator by causing the battery separator, which is being transferred, to pass through a washing liquid in a washing tank, in the transferring step, driving force for transfer is applied to the battery separator between a position at which the battery separator is brought into the washing tank and a position at which the battery separator is taken out from the washing tank.

The fourth aspect is an aspect in which, for example, driving force for transfer is applied to the heat-resistant separator S (battery separator) by the driving roller R between a position at which the heat-resistant separator S is brought into the washing tank and a position at which the heat-resistant separator S is taken out from the washing tank which is at least one of the washing tanks 15 through 19 which are illustrated in FIG. 4. According to the fourth aspect, force applied to the battery separator is dispersed, as compared with a case where the battery separator is pulled merely from a location downstream from the part at which the washing step is carried out. As a result, it is possible to inhibit a problem such as cutoff of the battery separator.

Note that, in a case where a mechanism for applying driving force to the battery separator is provided in the washing liquid, the position at which the battery separator is brought into the washing tank can be a position at which the battery separator is brought into the washing water in the washing tank and the position at which the battery separator is taken out from the washing tank can be a position at which the battery separator is taken out from the washing water in the washing tank.

A separator producing method in accordance with a fifth aspect of the present invention includes: a forming step of forming a long and porous battery separator; and steps in the separator washing method in accordance with any one of the first through fourth aspects, the steps in, the separator washing method being carried out after the forming step.

In the fifth aspect, for example, a heat-resistant separator S (battery separator) including a porous film 5 and a heat-resistant layer 4 laminated on the porous film 5 (see FIG. 3) are formed, and then the heat-resistant separator S is washed in at least one of the washing tanks 15 through 19 illustrated in FIG. 4. According to the fifth aspect, it is possible to produce the battery separator in which problems are inhibited and which has an air permeability higher than that of a conventional battery separator.

According to a separator producing method in accordance with a sixth aspect of the present invention, it is possible in the fifth aspect that the battery separator is a laminated separator including a base material and a functional layer laminated on the base material; and the forming step includes (i) an applying step of applying a liquid substance containing a substance for constituting the functional layer to the base material so as to laminate the functional layer and (ii) a solidifying step of solidifying the substance after the applying step.

In the sixth aspect, for example, in order to laminate a heat-resistant layer 4 (functional layer) on a porous film 5 (base material) as illustrated in FIG. 3, NMP (liquid substance) containing aramid resin (substance) for constituting the heat-resistant layer 4 is applied to the porous film 5, the aramid resin is solidified, and the heat-resistant separator S is washed in at least one of the washing tanks 15 through 19 illustrated in FIG. 4. According to the sixth aspect, it is possible to produce the laminated separator in which problems are inhibited and which has an air permeability higher than that of a conventional laminated separator.

A separator washing method in accordance with a seventh aspect of the present invention includes, in a film washing method for obtaining a long and porous battery separator, the steps of: transferring a film which is long and is an intermediate product of the battery separator in a lengthwise direction of the film; and washing the film by causing the film, which is being transferred, to pass through a washing liquid in a washing tank, the film containing polyolefin as a main component.

In the seventh aspect, for example, a polyolefin resin composition obtained by kneading polyolefin and an inorganic filler or a plasticizer is formed into a film, and this film is stretched to be an intermediate product of a heat-resistant separator S (battery separator). Then, the intermediate product is washed in at least one of the washing tanks 15 through 19 illustrated in FIG. 4, and thus the inorganic filler or the plasticizer is washed away. According to the seventh aspect, it is possible to obtain the polyolefin separator in which problems are inhibited and which has an air permeability higher than that of a conventional polyolefin separator.

A separator washing method in accordance with an eighth aspect of the present invention includes: a forming step of forming a film which is long and is an intermediate product of a long and porous battery separator; a transferring step of transferring the film in a lengthwise direction of the film; and a washing step of washing the film by causing the film, which is being transferred, to pass through a washing liquid in a washing tank, the transferring step and the washing step being carried out after the forming step.

In the eighth aspect, for example, a polyolefin resin composition obtained by kneading polyolefin and an inorganic filler or a plasticizer is formed into a film, and this film is stretched to be an intermediate product of a heat-resistant separator S (battery separator). Then, the intermediate product is washed in at least one of the washing tanks 15 through 19 illustrated in FIG. 4. According to the eighth, aspect, it is possible to produce the battery separator in which problems are inhibited and which has an air permeability higher than that of a conventional battery separator.

### Embodiment 4

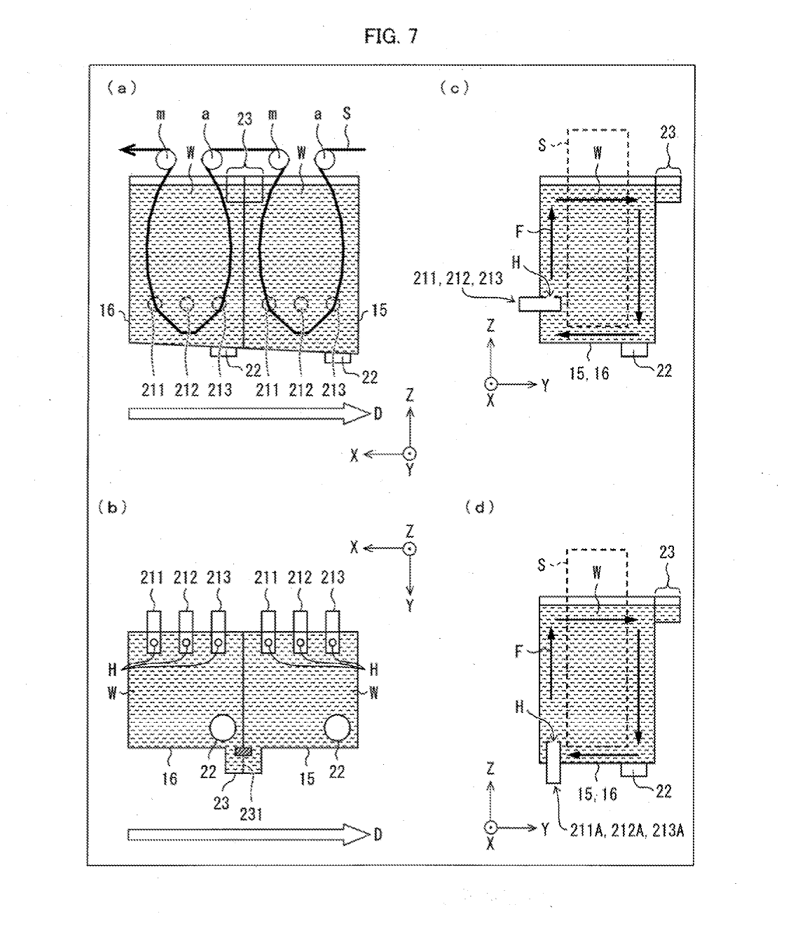

The following description will discuss Embodiment 4 of the present invention with reference to FIG. 7.

<<Configuration for Circulating Washing Water in Washing Tank>>

FIG. 7 is a set of views (a) through (d) illustrating configurations for circulating washing water W in each of washing tanks 15 and 16 in accordance with Embodiment 4. (a) of FIG. 7 is a side cross-sectional view. (b) of FIG. 7 is a plan view. (c) of FIG. 7 is a front cross-sectional view. (d) of FIG. 7 is a front cross-sectional view illustrating a configuration different from that of (c) of FIG. 7. Note that an X coordinate axis, a Y coordinate axis, and a Z coordinate axis of FIG. 7 respectively correspond to an X coordinate axis, a Y coordinate axis, and a Z coordinate axis of each of drawings other than FIG. 7. Note also that (a) of FIG. 7 corresponds to FIG. 4. For simplification of the drawing, (a) of FIG. 7 illustrates only rollers a and m of all the rollers a through m of FIG. 4. Note also that (b) of FIG. 7 illustrates neither the rollers a through m of FIG. 4 nor the heat-resistant separator S of FIG. 4. Neither (c) nor (d) of FIG. 7 illustrates the rollers a through m of FIG. 4, and (c) and (d) of FIG. 7 each show the heat-resistant separator S by a broken line.

As illustrated in (a) and (b) of FIG. 7, the washing tank 15 includes discharging sections 211 through 213 and a suction port 22. The discharging sections 211 through 213 are provided so as to protrude from a part of an inner wall at a negative side of the Y-axis of the washing tank 15, which part is located toward a negative side of the Z-axis. On a positive side of the Z-axis (upper side) of each of the discharging sections 211 through 213, a discharge port H is provided. The suction port 22 is provided toward a positive side of the Y-axis and a negative side of the X-axis of a bottom surface of the washing tank 15. As is the case of the washing tank 15, the washing tank 16 likewise includes discharging sections 211 through 213 and a suction port 22.

<<Operation for Circulating Washing Water in Washing Tank>>

The discharging sections 211 through 213 of the washing tank 15 guide washing water W, which is located outside the washing tank 15, into the washing tank 15. The discharge ports 1H discharge the washing water W, which has been thus guided into the washing tank 15, toward the positive side of the Z-axis. Then, as illustrated in (c) of FIG. 7, the washing water W flows in a direction F in the vicinity of the inner wall which faces a widthwise end part of the heat-resistant separator S and which is located at the negative side of the Y-axis of the washing tank 15. Note that “widthwise” herein means directions perpendicular to both lengthwise directions and thicknesswise directions of the heat-resistant separator S.

The suction port 22 sucks out the washing water W inside the washing tank 15. Then, the washing water W thus sucked by the suction port 22 is discharged through the discharging sections 211 through 213 of the washing tank 15. This circulates the washing water W inside the washing tank 15 as detailed in the following (1) through (4).

(1) The washing water W is discharged so as to flow from the negative side of the Z-axis toward the positive side of the Z-axis in the vicinity of the inner wall at the negative side of the Y-axis of the washing tank 15.
(2) The washing water W flows from the negative side of the Y-axis toward the positive side of the Y-axis at a water surface side (at the positive side of the Z-axis) of the washing tank 15. Specifically, the washing water W flows from the inner wall at the negative side of the Y-axis to an inner wall at the positive side of the Y-axis at an upper part of the washing tank 15.
(3) The washing water W is sucked so as to flow from the positive side of the Z-axis toward the negative side of the Z-axis in the vicinity of the inner wall at the positive side of the Y-axis of the washing tank 15.
(4) The washing water W flows from the positive side of the Y-axis toward the negative side of the Y-axis in the vicinity of the bottom surface of the washing tank 15. Specifically, the washing water W flows from the inner wall at the positive side of the Y-axis toward the inner wall at the negative side of the Y-axis in the vicinity of the bottom surface of the washing tank 15. Note that the washing water W likewise circulates in the washing tank 16 as in the washing tank 15.

<<Effect of Embodiment 4>>

The film production method in accordance with Embodiment 4 includes the steps of (i) transferring the heat-resistant separator S in a lengthwise direction so that the heat-resistant separator S passes through water in the washing tank 15 (see (a) of FIG. 7) and (ii) upwardly discharging the washing water W which has been guided into the washing tank 15 through the inner wall of the washing tank 15, which inner wall faces the widthwise end part of the heat-resistant separator S (see (c) of FIG. 7).

According to the above configuration, the washing water W flows between the heat-resistant separator S and the inner wall of the washing tank 15, which inner wall faces the widthwise end part of the heat-resistant separator S and circulates in the washing tank 15. This causes the washing water W, which is flowing, to push a surface of the heat-resistant separator S, and therefore restricts force that is applied to the heat-resistant separator S. In addition, the washing water W at the surface of the heat-resistant separator S is renewed, so that removal of a remove-target substance in the heat-resistant separator S is facilitated. This makes it possible to produce a heat-resistant separator S on which a remaining remove-target substance is restricted, while a problem that occurs to the heat-resistant separator S is inhibited.

Note that the number of discharging sections included in the washing tank 15 is not limited to three. Note also that the number of suction ports included in the washing tank 15 is not limited to one. These numbers can vary depending on, for example, (i) dimensions of the washing tank 15, (ii) a washing capability required of the washing tank 15, (iii) a flow rate of the washing water W, or (iv) a transferring path of the heat-resistant separator S. For example, in a case where the number of discharging sections is increased, the washing water W can flow (a) at a plurality of locations corresponding to the number of discharging sections and (b) in the vicinity of the inner wall of the washing tank 15, which inner wall faces the widthwise end part of the heat-resistant separator S. This allows a greater amount of the washing water W at the surface of the heat-resistant separator S to be renewed, and therefore further facilitates the removal of a remove-target substance in the heat-resistant separator S.

Alternatively, the discharging sections 211 through 213 and the suction port 22 can be included in each of the washing tanks 17 through 19 illustrated in FIG. 4. In a case where at least one of the washing tanks 15 through 19 includes discharging sections 211 through 213, it is possible to produce a heat-resistant separator S on which a remaining remove-target substance is restricted, while a problem that occurs to the heat-resistant separator S is restricted.

(Direction in which Washing Water W is Discharged)

The direction F, in which the washing water W is discharged from the discharge ports H, is set so that a virtual straight line extending in the direction F from the discharge ports H pass between the heat-resistant separator S and the inner wall of the washing tank 15, which inner wall faces the widthwise end part of the heat-resistant separator S (see (c) of FIG. 7). This allows washing water W at one side and the other side of the heat-resistant separator S to be interchanged.

The direction F is also set so that no part of the heat-resistant separator S is located (i) on the virtual straight line extending in the direction F from the discharge ports H and (ii) in the water. This causes the washing water W, which is flowing, to push the surface of the heat-resistant separator S, and therefore reliably restricts force that is applied to the heat-resistant separator S. Meanwhile, the washing water W at one side and the other side of the film can be interchanged.

Furthermore, the discharge ports H are provided on a side of the discharging sections 211 through 213, which side faces a direction (Z-axis direction in Embodiment 4) perpendicular to rotation axes of the rollers a through m. Note that the direction perpendicular to the rotation axes of the rollers a through m only needs to be a direction in which the washing water W is discharged from the discharge ports H along the inner wall of the washing tank 15. For example, the discharge ports H can be provided on a side of the discharging sections 211 through 213, which side faces a direction falling within a range of angles of equal to or greater than 60′ and equal to or less than 90° with respect to the rotation axes of the rollers a through m.

In (a) of FIG. 7, at least the discharging section 212 is provided between (i) part of the heat-resistant separator S being transferred downwardly and (ii) part of the heat-resistant separator S being transferred upwardly. This causes the washing water W to pass between (i) the part of the heat-resistant separator S being transferred downwardly and (ii) the part of the heat-resistant separator S being transferred upwardly. Therefore, it is possible to facilitate renewing of washing water W between (i) the part of the heat-resistant separator S being transferred downwardly and (ii) the part of the heat-resistant separator S being transferred upwardly.

Furthermore, discharging sections 211A, 212A, and 213A illustrated in (d) of FIG. 7 also exert an effect similar to that of the discharging sections 211 through 213 illustrated in (c) of FIG. 7. Specifically, it is possible to guide washing water W into the washing tank 15 through a part of the bottom surface of the washing tank 15, which part is (i) of an inner wall of the washing tank 15, which inner wall faces a widthwise end part of the heat-resistant separator S and (ii) close to the inner wall at the negative side of the Y-axis. Then, it is possible to discharge the washing water W upwardly.

(Detour 23)

As illustrated in (b) and (c) of FIG. 7, between the washing tank 15 (first washing tank) and the washing tank 16 (second washing tank), there is a detour 23 provided for moving washing water W from the washing tank 16 to the washing tank 15. The detour 23 has an inflow port through which the washing water W flows in the detour 23. The inflow port is provided at a part of an inner wall of the washing tank 16 at the positive side of the Y-axis, which part is located toward the negative side of the X-axis and the positive side of the Z-axis. The detour 23 also has an outflow port through which washing water W flows out of the detour 23. The outflow port is provided at a part of the inner wall at the positive side of the Y-axis of the washing tank 15, which part is located toward the negative side of the X-axis and the positive side of the Z-axis. This allows part of the washing water W to move from the washing tank 16 to the washing tank 15 without interfering with the flow of the washing water W in the vicinity of the inner walls of the respective washing tanks 15 and 16, which inner walls face respective widthwise end parts of the heat-resistant separator S. In addition, as illustrated in (b) of FIG. 7, the detour 23 includes a filter 231. This prevents a suspended matter in the washing tank 16 from flowing into the washing tank 15.

Alternatively, a detour 23 can be provided between two adjacent ones of the washing tanks 16 through 19. Alternatively, a detour can be provided between each set of two adjacent ones of the washing tanks 16 through 19. In such a case, as illustrated in FIG. 4, washing water W flows in a direction D from the washing tank 19 to the washing tank 15. Then, the washing tank 19 is supplied with new washing water W. In addition, part of the washing water W is drained from the washing tank 15.

(Variations of Detour 23)

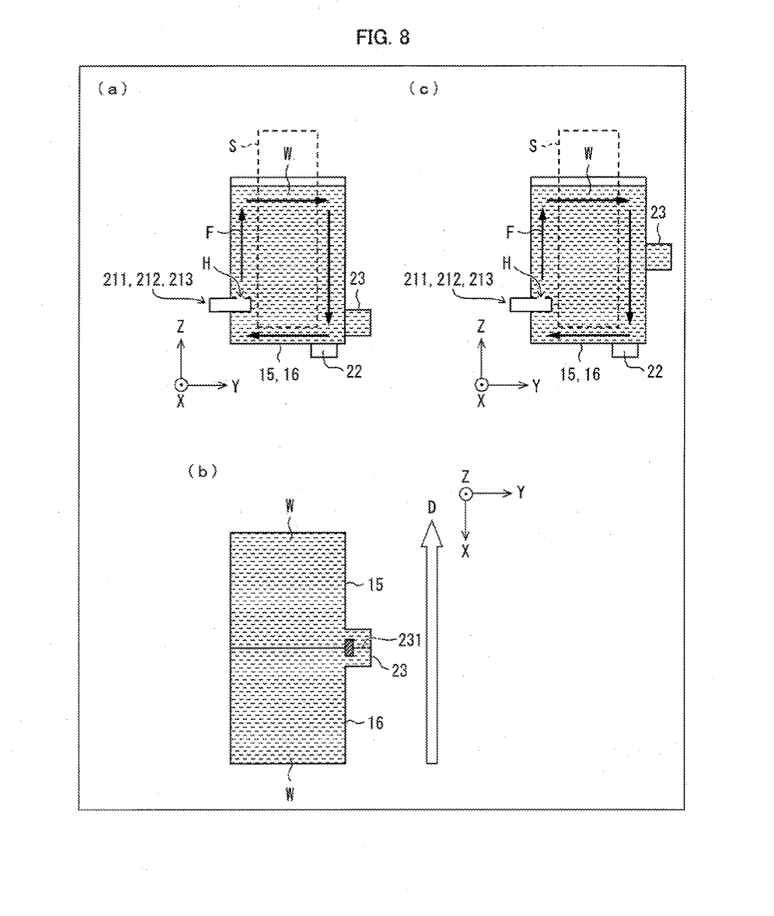

FIG. 8 is a set of views illustrating variations of the detour 23 illustrated in FIG. 7. (a) of FIG. 8 is a front cross-sectional view. (b) of FIG. 8 is a parallel cross-sectional view including the detour 23 illustrated in (a) of FIG. 8. (c) of FIG. 8 is a front cross-sectional view illustrating a further variation other than the variation illustrated in (a) of FIG. 8.

As illustrated in (a) of FIG. 8, a detour 23 can be provided at bottom surfaces of the respective washing tanks 15 and 16 or in the vicinity of the bottom surfaces. As illustrated in (b) of FIG. 8, in the parallel cross section including the detour 23, the detour 23 connects the washing tank 15 and the washing tank 16.

As illustrated in (c) of FIG. 8, a detour 23 can be provided at a midpoint between (i) bottom surfaces of the respective washing tanks 15 and 16 and (ii) a water surface of the washing tanks 15 and 16.

As has been described, the detour 23 can be provided at any location that connects the washing tank 15 and the washing tank 16. Alternatively, the detour 23 can connect the washing tank 15 and the washing tank 16 at a negative side of a Y-axis.

(Pipe that Connects Washing Tanks)

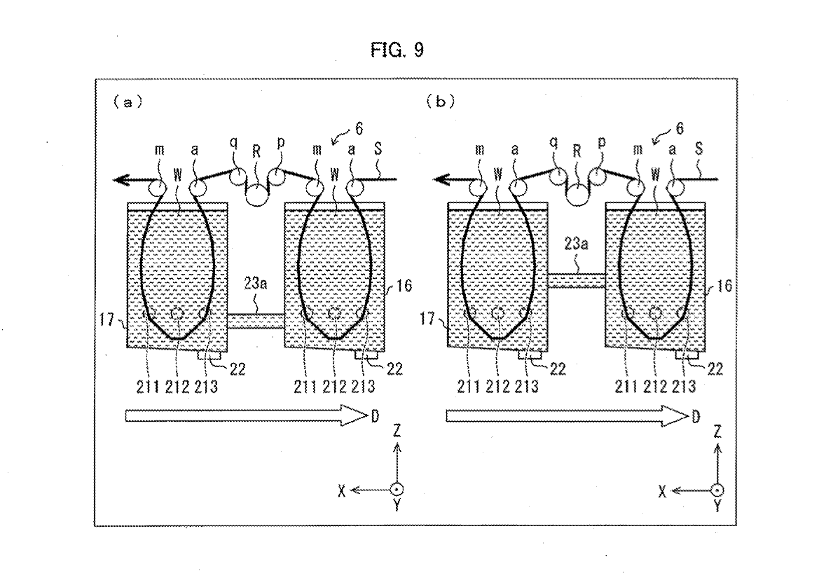

FIG. 9 is a set of side cross-sectional views each illustrating a configuration of a pipe 23a provided between the washing tank 16 and the washing tank 17 of the washing device 6 illustrated in FIG. 4. (a) of FIG. 9 shows a cross section including the pipe 23a. (b) of FIG. 9 illustrates a variation of the configuration illustrated in (a) of FIG. 9.

As illustrated in (a) of FIG. 9, the pipe 23a extends along an X-axis so as to connect the washing tank 16 and the washing tank 17. The pipe 23a is provided in the vicinity of bottom surfaces of respective washing tanks 16 and 17. The pipe 23a is a variation of the detour 23 illustrated in FIG. 7 such that the pipe 23a has a function similar to that of the detour 23.

The pipe 23a has an inflow port which is provided on a wall surface of the washing tank 17, which wall surface is located at a negative side of the X-axis. Washing water W flows from the washing tank 17 into the pipe 23a through the inflow port. The pipe 23a also has an outflow port which is provided on a wall surface of the washing tank 16, which wall surface is located at a positive side of the X-axis. The washing water W flows out from the pipe 23a to the washing tank 16 through the outflow port.

As illustrated in (b) of FIG. 9, a pipe 23a can be provided at a midpoint between (i) bottom surfaces of the respective washing tanks 16 and 17 and (ii) a water surface of the washing tanks 16 and 17. Alternatively, the pipe 23a can be provided in the vicinity of the water surface of the washing tanks 16 and 17.

As has been described, the pipe 23a can be provided at any location that connects the washing tank 16 and the washing tank 17.

(Inclination of Bottom Surface of Washing Tank)

As illustrated in (a) of FIG. 7, the bottom surface of the washing tank 15 is inclined so as to become deeper downstream in relation to a direction D than it does upstream in relation to the direction D. This allows, during maintenance, washing water W to be drained from the washing tank 15 without the washing water W remaining in the washing tank 15.

The suction port 22 is provided at a part of the bottom surface of the washing tank 15, which part is located downstream in relation to the direction D. The bottom surface of the washing tank 15 is inclined so that the part of the bottom surface of the washing tank 15 located downstream in relation to the direction D is deeper than the other part of the bottom surface located upstream in relation to the direction D. This causes a precipitate, which is generated in the washing tank 15, to be concentrated in the part of the bottom surface of the washing tank 15 downstream in relation to the direction D, which part is deeper. Therefore, the precipitate is concentrated toward the suction port 22.

As has been described, washing water W, which has been sucked by the suction port 22, is then discharged from the discharging sections 211 through 213 of the washing tank 15. In so doing, the precipitate can be removed by, for example, filtering the precipitate before the washing water W is discharged from the discharging sections 211 through 213.

As has been described, washing water W flows in the direction D. Therefore, it is preferable that part of the bottom surface of the washing tank 15, which part is located toward the negative side of the X-axis (i.e. the side from which a heat-resistant separator S is brought into the washing tank 15), is lower than the other part which is located toward the positive side of the X-axis (i.e. the side from which the heat-resistant separator S is taken out of the washing tank 15).

(Another Configuration Example 1 of Discharging Sections)

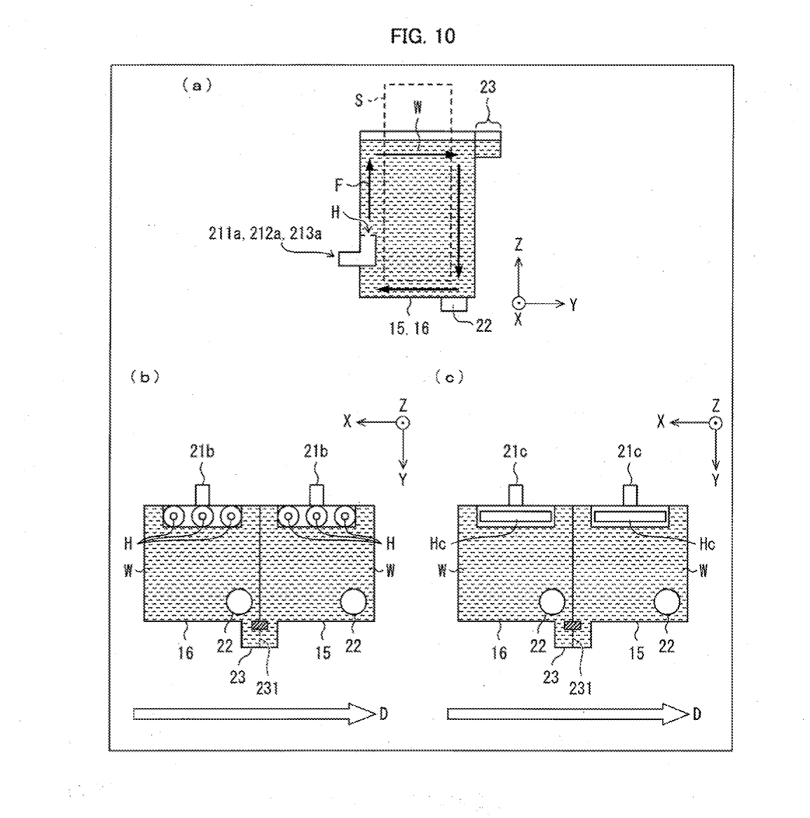

FIG. 10 is a set of views illustrating other configurations of discharging sections 211 through 213 of the washing tanks 15 and 16 illustrated in FIG. 7. (a) of FIG. 10 is a front cross-sectional view illustrating a configuration of discharging sections 211a through 213a which are obtained by respectively changing shapes of the discharging sections 211 through 213 illustrated in (c) of FIG. 7. As illustrated in (a) of FIG. 10, parts of the discharging sections 211a through 213a, which parts are located in the washing tank 15, extend toward a positive side of a Z-axis along an inner wall at a negative side of a Y-axis of the washing tank 15.

According to the above configuration, washing water W, immediately before being discharged from the discharging sections 211a through 213a, is adjusted so as to flow (i) in the discharging sections 211a through 213a, (ii) in the vicinity of the inner wall at the negative side of the Y-axis of the washing tank 15, and (iii) toward the positive side of the Z-axis. This allows, after the washing water W is discharged from the discharging sections 211a through 213a, the washing water WV to reliably flow in a direction F in the vicinity of an inner wall of the washing tank 15, which inner wall faces a widthwise end part of a heat-resistant separator S.

(Another Configuration. Example 2 of Discharging Sections)

(b) of FIG. 10 is a plan view illustrating a configuration of discharging sections 21b which are obtained by integrating providing sources of the respective discharging sections 211a through 213a illustrated in (a) of FIG. 10, from which providing sources washing water W is provided. Note that (b) of FIG. 10 corresponds to (b) of FIG. 7. As illustrated in (b) of FIG. 10, an end part (discharge side) of a discharging section 21b, which end part is located inside the washing tank 15, is divided into three pieces. An end part (providing source) of the discharging section 21b, which end part is located outside the washing tank 15, is integrated. Note that a shape of each of the discharging sections 21b in a front cross section of the washing tank 15 is similar to that of each of the discharging sections 211a through 213a illustrated in (a) of FIG. 10.

According to the above configuration, washing water W is discharged from three discharge ports H at substantially a uniform flow velocity. This allows, after washing water W is discharged from the three discharge ports H, the washing water W to flow at a uniform flow velocity in the direction F in the vicinity of an inner wall of the washing tank 15, which inner wall faces a widthwise end part of a heat-resistant separator S.

(Another Configuration Example 3 of Discharging Sections)

(c) of FIG. 10 is a plan view illustrating a configuration of discharging sections 21c having respective discharge ports Hc which are different in shape from discharge ports H of the respective discharging sections 21b illustrated in (b) of FIG. 10. As illustrated in (c) of FIG. 10, the discharging sections 21c each have a discharge port Hc obtained by integrating three discharge ports H illustrated in (b) of FIG. 10. The discharge port Hc spreads out in the X-axis directions in which an inner wall of the washing tank 15 extends. Note that a shape of each of the discharging sections 21c in a front cross section of the washing tank 15 is similar to that of each of the discharging sections 211a through 213a illustrated in (a) of FIG. 10.

According to the above configuration, washing water W is discharged at substantially a uniform flow velocity from discharge ports Hc which spread out in the X-axis directions. This allows, after washing water W is discharged from the discharge ports Hc, the washing water W to flow (i) at a uniform flow velocity in the X-axis directions and (ii) in a direction F in the vicinity of an inner wall of the washing tank 15, which inner wall faces a widthwise end part of a heat-resistant separator S. Note that the discharge ports Hc are not limited to a configuration in which the discharge ports Hc spread out in the X-axis directions, provided that the discharge ports Hc spread out in directions in which the inner wall extends.

(Film Production Device)

The present invention also encompasses a film production device which includes (i) a washing tank 15, (ii) rollers a through m (transferring device), and (iii) discharging sections 211 through 213 or discharging sections 211A through 213A. With the film production device, as is the case of the film production method described above, it is possible to produce a heat-resistant separator S on which a remaining remove-target substance is restricted, while a problem that occurs to the heat-resistant separator S is inhibited.

### Embodiment 51

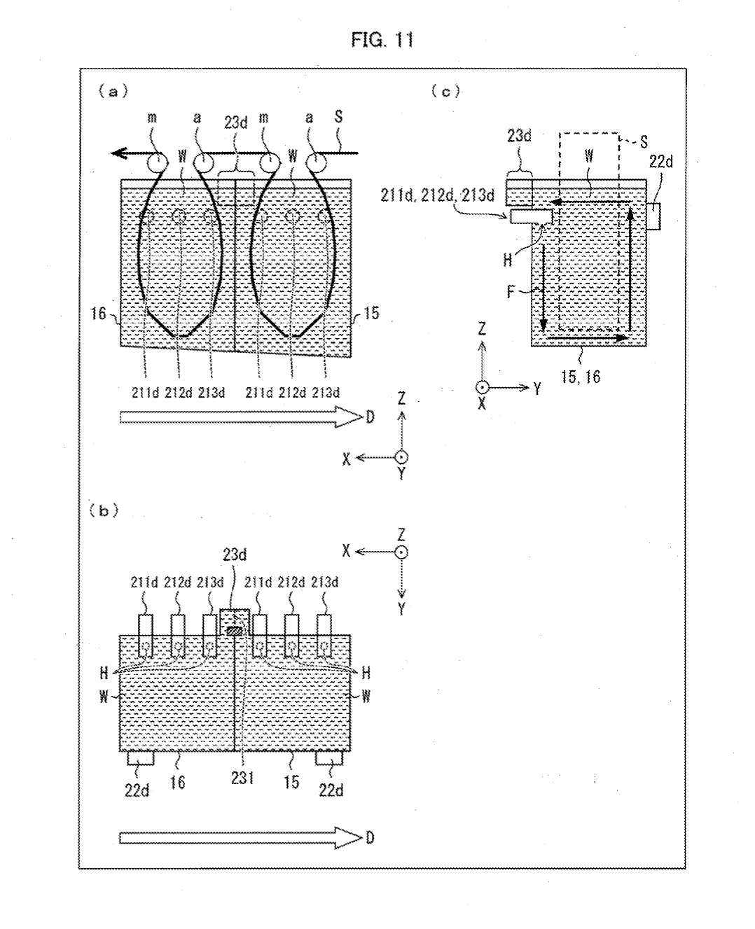

The following description will discuss Embodiment 5 of the present invention with reference to FIG. 11.

<<Another Configuration for Circulating Washing Water in Washing Tank>>

FIG. 11 is a set of views illustrating a configuration for circulating washing water W in each of washing tanks 15 and 16 in accordance with Embodiment 5. (a) of FIG. 11 is a side cross-sectional view. (b) of FIG. 11 is a plan view. (c) of FIG. 11 is a front cross-sectional view. (a) through (c) of FIG. 11 correspond to (a) through (c) of FIG. 7, respectively.

As illustrated in (a) and (b) of FIG. 11, the washing tank 15 includes discharging sections 211d, 212d, and 213d and a suction port 22d. The discharging sections 211d, 212d, and 213d are provided so as to protrude from a positive side of a Z-axis at an inner wall located at a negative side of a Y-axis of the washing tank 15. On a negative side of the Z-axis (lower side) of each of the discharging sections 211d, 212d, and 213d, a discharge port H is provided. The suction port 22d is provided toward the positive side of the Z-axis and a negative side of an X-axis of an inner wall at a positive side of the Y-axis of the washing tank 15. As is the case of the washing tank 15, the washing tank 16 likewise includes discharging sections 211d, 212d, and 213d and a suction port 22d. Note, however, that the suction port 22d of the washing tank 16 is provided toward the positive side of the Z-axis and a positive side of the X-axis of an inner wall at the positive side of the Y-axis of the washing tank 16.

<<Another Operation for Circulating Washing Water in Washing Tank>>

The discharging sections 211d, 212d, and 213d of the washing tank 15 guide washing water W, which is located outside the washing tank 15, into the washing tank 15. The discharge ports H discharge the washing water W, which has been thus guided into the washing tank 15, toward the negative side of the Z-axis. Then, as illustrated in (c) of FIG. 11, the washing water W flows in a direction F in the vicinity of an inner wall which faces a widthwise end part of a heat-resistant separator S and which is located at the negative side of the Y-axis of the washing tank 15.

The suction port 22d sucks out the washing water W inside the washing tank 15. Then, the washing water W thus sucked by the suction port 22d is discharged through, the discharging sections 211d, 212d, and 213d. This circulates the washing water W inside the washing tank 15 as detailed in the following (1d) through (4d).

(1d) The washing water W is discharged so as to flow from the positive side of the Z-axis toward the negative side of the Z-axis in the vicinity of the inner wall at the negative side of the Y-axis of the washing tank 15.
(2d) The washing water W flows from the negative side of the Y-axis toward the positive side of the Y-axis in the vicinity of a bottom surface of the washing tank 15. Specifically, the washing water W flows from the inner wall at the negative side of the Y-axis to an inner wall at the positive side of the Y-axis in the vicinity of the bottom surface of the washing tank 15.
(3d) The washing water W is sucked so as to flow from the negative side of the Z-axis toward the positive side of the Z-axis in the vicinity of the inner wall at the positive side of the Y-axis of the washing tank 15.
(4d) The washing water W flows from the positive side of the Y-axis toward the negative side of the Y-axis at a water surface side (at the positive side of the Z-axis) of the washing tank 15. Specifically, the washing water W flows from the inner wall at the positive side of the Y-axis toward the inner wall at the negative side of the Y-axis at an upper side of the washing tank 15.
Note that, in so doing, a direction of circulation of the washing water W is opposite the direction of circulation of the washing water W illustrated in (c) of FIG. 7 in terms of vertical directions (Z-axis directions). The washing water W likewise circulates in the washing tank 16 as in the washing tank 15.

<<Effect of Embodiment 5>>

The film production method in accordance with Embodiment 5 includes the steps of (i) transferring the heat-resistant separator S in a lengthwise direction so that the heat-resistant separator S passes through water in the washing tank 15 (see (a) of FIG. 11) and (ii) upwardly guiding the washing water W which has been guided into the washing tank 15 through the inner wall of the washing tank 15, which inner wall faces the widthwise end part of the heat-resistant separator S (see (c) of FIG. 11).

According to the above configuration, the washing water W flows between the heat-resistant separator S and the inner wall of the washing tank 15, which inner wall faces the widthwise end part of the heat-resistant separator S, and circulates in the washing tank 15. This causes the washing water W, which is flowing, to push a surface of the heat-resistant separator S, and therefore restricts force that is applied to the heat-resistant separator S. In addition, the washing water W at the surface of the heat-resistant separator S is renewed, so that removal of a remove-target substance in the heat-resistant separator S is facilitated. This makes it possible to produce a heat-resistant separator S on which a remaining remove-target substance is restricted, while a problem that occurs to the heat-resistant separator S is inhibited.

Note that the number of discharging sections included in the washing tank 15 is not limited to three. Note also that the number of suction ports included in the washing tank 15 is not limited to one. These numbers can vary depending on, for example, (i) dimensions of the washing tank 15, (ii) a washing capability required of the washing tank 15, (iii) a flow rate of the washing water W, or (iv) a transferring path of the heat-resistant separator S.

Alternatively, the discharging sections 211d, 212d, and 213d and the suction port 22d can be included in each of the washing tanks 17 through 19 illustrated in FIG. 4. In a case where at least one of the washing tanks 15 through 19 includes discharging sections 211d, 212d, and 213d, it is possible to produce a heat-resistant separator S on which a remaining remove-target substance is restricted, while a problem that occurs to the heat-resistant separator S is restricted.

(Detour 23d)

According to Embodiment 5, the washing tank 15 and the washing tank 16 are each connected to a detour 23d. As is the case of the detour 23, the detour 23d includes a filter 231. Note, however, that unlike the detour 23, the detour 23d connects the washing tank 15 and the washing tank 16 at the negative side of the Y-axis.

As is the case of the detour 23 illustrated in FIG. 8, the detour 23d can be provided at any location that connects the washing tank 15 and the washing tank 16. Alternatively, the detour 23d can connect the washing tank 15 and the washing tank 16 at the positive side of the Y-axis.

(Film Production Device)

The present invention also encompasses a film production device which includes (i) a washing tank 15, (ii) rollers a through m (transferring device), and (iii) discharging sections 211d through 213d. With the film production device, as is the case of the film production method described above, it is possible to produce a heat-resistant separator S on which a remaining remove-target substance is restricted, while a problem, that occurs to the heat-resistant separator S is inhibited.

### SUMMARY

A film production method of the present invention is a method for producing a film, including the steps of: (a) transferring a film in a lengthwise direction so that the film passes through a liquid in a liquid tank; and (b) upwardly or downwardly discharging the liquid which has been guided into the liquid tank through an inner wall of the liquid tank, which inner wall faces a widthwise end part of the film.

In a case where a film being washed is subjected to force which is applied in a direction other than a direction in which the film is being transferred, there is a risk that problems such as folds, creases, and tears may occur.

According to the method, a liquid flows upwardly or downwardly in the vicinity of the inner wall of the liquid tank, which inner wall faces the widthwise end part of the film. Therefore, the liquid flows between the film and the inner wall. This causes the liquid, which is flowing, to push a surface of the film, and therefore restricts force that is applied to the film. In addition, the liquid at the surface of the film is renewed, so that removal of a remove-target substance in the film is facilitated. This makes it possible to produce a film on which a remaining remove-target substance is restricted, while a problem that occurs to the film is inhibited. Note that “widthwise” directions of the film herein means directions perpendicular to both lengthwise directions and thicknesswise directions of the film.

The film production method of the present invention is preferably configured so that in the step (b), the liquid is guided into the liquid tank through a discharging section protruding from the inner wall, and is discharged from a discharge port which is provided on an upper side or a lower side of the discharging section.

According to the method, the discharging section can discharge the liquid via the discharge port so that the liquid reliably flows upwardly or downwardly in the vicinity of the inner wall of the liquid tank, which inner wall faces the widthwise end part of the film.

The film production method of the present invention is preferably configured so that in the step (b), a direction in which the liquid is discharged from the discharge port is set so that a virtual straight line extending in the direction passes between the film and the inner wall in the liquid.

According to the method, the liquid passes between the film and the inner wall of the liquid tank, which inner wall faces the widthwise end part of the film. This allows liquids at one side and the other side of the film to be interchanged.

The film production method of the present invention is preferably configured so that in the step (b), the direction in which the liquid is discharged is set so that no part of the film is located on the virtual straight line and in the liquid.

According to the method, the liquid, which is flowing, pushes the surface of the film, and therefore force applied to the film is reliably restricted. Meanwhile, the liquid at one side and the other side of the film can be interchanged.

The film production method of the present invention is preferably configured so that: in the step (a), the film is transferred with use of a roller; and in the step (b), the discharge port is provided on a side of the discharging section, which side faces a direction perpendicular to a rotation axis of the roller.

The film production method of the present invention is preferably configured so that in the step (b), the discharging section extends along the inner wall.

According to the method, the liquid, immediately before being discharged from the discharging section, is adjusted to flow in the discharging section and in the vicinity of the inner wall of the liquid tank. This allows, after the liquid is discharged from the discharging section, the liquid to reliably flow in the vicinity of the inner wall of the liquid tank, which inner wall faces the widthwise end part of the film.

The film production method of the present invention is preferably configured so that in the step (b), the discharge port spreads out along directions in which the inner wall extends.

According to the method, the liquid is discharged at substantially a uniform flow velocity from the discharge port which spreads out in the directions in which the inner wall extends. This allows, after the liquid is discharged from the discharge port, the liquid to flow (i) in a direction in which the inner wall extends, (ii) at a uniform flow velocity, and (iii) in the vicinity of the inner wall of the liquid tank, which inner wall faces the widthwise end part of the film.

The film production method of the present invention is preferably configured so that in the step (b), the liquid is provided into the liquid tank through a plurality of the discharging sections.

According to the method, the liquid can flow (a) at a plurality of locations corresponding to the number of discharging sections and (b) in the vicinity of the inner wall of the liquid tank, which inner wall faces the widthwise end part of the film. This allows a greater amount of the liquid at the surface of the film to be renewed, and therefore further facilitates the removal of a remove-target substance in the film.

The film production method of the present invention is preferably configured so that in the step (b), the plurality of the discharging sections have an integrated source from which the liquid is provided.

According to the method, the liquid is discharged at substantially a uniform flow velocity from the plurality of the discharging sections. This allows, after the liquid is discharged from the plurality of the discharging sections, the liquid to flow at a uniform flow velocity, in the vicinity of the inner wall of the liquid tank, which inner wall faces the widthwise end part of the film.

The film production method of the present invention is preferably configured so as to further include the step of: (c) sucking out the liquid from a part that is located (i) on a bottom surface of the liquid tank and (ii) closer to an inner wall facing the inner wall from which the liquid is guided into the liquid tank than to the inner wall from which the liquid is guided into the liquid tank, in the step (b), the liquid being upwardly discharged.

According to the method, the liquid circulates in the liquid tank as follows.

(1) The liquid is discharged so as to flow in one direction in the vicinity of the inner wall of the liquid tank, through which inner wall the liquid is guided into the liquid tank (hereinafter, this inner wall will be referred to as “guiding inner wall”).
(2) The liquid flows from the guiding inner wall toward the inner wall of the liquid tank, which inner wall faces the guiding inner wall (hereinafter, this inner wall will be referred to as “counter inner wall”).
(3) The liquid is sucked so as to flow (i) in the vicinity of the counter inner wall and (ii) in a direction opposite the above one direction.
(4) The liquid flows from the counter inner wall toward the guiding inner wall.
This allows the liquid to circulate throughout an entire portion of the liquid tank, and therefore facilitates renewing of a liquid on an entire surface of the film.

The film production method of the present invention is preferably configured so as to further include the step of: (d) sucking out the liquid from a part that is located (i) on an inner wall facing the inner wall from which the liquid is guided into the liquid tank and (ii) closer to a liquid surface of the liquid than to a bottom surface of the liquid tank, in the step (b), the liquid being downwardly discharged. With the production method also, it is possible to circulate a liquid throughout the entire portion of the liquid tank.

The film production method of the present invention is preferably configured so that the liquid tank has an inclined bottom surface.

According to the method, the liquid flows in a direction in which the bottom surface is inclined. This allows, during maintenance, liquid to be drained from the liquid tank without the liquid remaining in the liquid tank.

The film production method of the present invention is preferably configured so as to further include the step of: (e) sucking out the liquid from a lower part of an inclined bottom surface of the liquid tank is inclined.

According to the method, a precipitate, which is generated in the liquid tank, is concentrated toward a lower part of the bottom surface of the liquid tank. Therefore, the precipitate is concentrated toward the part from which the liquid is sucked out. In so doing, the precipitate can be removed by, for example, filtering the liquid thus sucked out.

The film production method of the present invention is preferably configured so that the inclined bottom surface is configured so that a part located toward a side from which the film is brought into the liquid tank in the step (a) is lower than another part located toward a side from which the film is taken out of the liquid tank in the step (a).

The film production method of the present invention is preferably configured so that in the step (a), the film being transferred in the lengthwise direction so as to pass through the liquid in a first liquid tank and in a second liquid tank; and in the step (b), the liquid is guided into the first liquid tank through an inner wall of the first liquid tank, which inner wall faces the widthwise end part of the film, and is then upwardly or downwardly discharged, and the liquid is guided into the second liquid tank through an inner wall of the second liquid tank, which inner wall faces the widthwise end part of the film and is then upwardly or downwardly discharged, the method preferably further including the step of: (f) moving the liquid from the second liquid tank to the first liquid tank.

According to the method, part of the liquid can move between the first liquid tank and the second liquid tank without interfering with flows of liquid in the vicinity of the inner walls of the respective first and second liquid tanks, which inner walls face respective widthwise end parts of the film. In addition, a suspended matter, for example, can be removed in a pathway through which a liquid tank moves between the first liquid tank and the second liquid tank. This prevents a suspended matter in the second liquid tank from flowing into the first liquid tank.

The another film production method of the present invention is a method for producing a film, including the steps of: (a) transferring a film in a lengthwise direction so that the film passes through a liquid in a liquid tank; and (b) upwardly discharging the liquid which has been guided into the liquid tank through a part of a bottom surface of the liquid tank, the part being located closer to one or the other one of two inner walls of the liquid tank, which two inner walls face respective widthwise end parts of the film.

A film production device of the present invention includes: a liquid tank; a transferring device for transferring a film in a lengthwise direction so that the film passes through a liquid in the liquid tank; and a discharging section for upwardly or downwardly discharging the liquid which has been guided into the liquid tank through an inner wall of the liquid tank, which inner wall faces a widthwise end part of the film.

Another film production device of the present invention includes: a liquid tank; a transferring device for transferring a film in a lengthwise direction so that the film passes through a liquid in the liquid tank; and a discharging section for upwardly or downwardly discharging the liquid which has been guided into the liquid tank through a part of a bottom surface of the liquid tank, the part being located closer to one or the other one of two inner walls of the liquid tank, which two inner walls face respective widthwise end parts of the film.

### ADDITIONAL REMARKS

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### INDUSTRIAL APPLICABILITY

The present invention can be used for production of any film other than a separator.

### REFERENCE SIGNS LIST

4 Heat-resistant layer (functional layer)
5 Porous film (base material)
6 Washing device
15 through 19 Washing tank (liquid tank)
21b, 21c, 211 through 213, 211A through 213A, 211a through 213a, 211d through 213d Discharging section
22, 22d Suction port
23, 23d Detour
23a Pipe
BL Scrape-off bar
G Guide roll
H, Hc Discharge port
R Driving roller
S Heat-resistant separator (battery separator, laminated separator, film)
W Washing water (liquid)
a through m Roller (transferring roller)
p, q Auxiliary roller
s Teflon bar
t Teflon tube

1. A method for producing a film, comprising the steps of:
(a) transferring a film in a lengthwise direction so that the film passes through a liquid in a liquid tank; and
(b) upwardly or downwardly discharging the liquid which has been guided into the liquid tank through an inner wall of the liquid tank, which inner wall faces a widthwise end part of the film.

2. The method as set forth in claim 1, wherein
in the step (b), the liquid is guided into the liquid tank through a discharging section protruding from the inner wall, and is discharged from a discharge port which is provided on an upper side or a lower side of the discharging section.

3. The method as set forth in claim 2, wherein
in the step (b), a direction in which the liquid is discharged from the discharge port is set so that a virtual straight line extending in the direction passes between the film and the inner wall in the liquid.

4. The method as set forth in claim 3, wherein
in the step (b), the direction in which the liquid is discharged is set so that no part of the film is located on the virtual straight line and in the liquid.

5. The method as set forth in claim 2, wherein:
in the step (a), the film is transferred with use of a roller; and
in the step (b), the discharge port is provided on a side of the discharging section, which side faces a direction perpendicular to a rotation axis of the roller.

6. The method as set forth in claim 2, wherein
in the step (b), the discharging section extends along the inner wall.

7. The method as set forth in claim 2, wherein
in the step (b), the discharge port spreads out along directions in which the inner wall extends.

8. The method as set forth in claim 2, wherein
in the step (b), the liquid is provided into the liquid tank through a plurality of the discharging sections.

9. The method as set forth in claim 8, wherein
in the step (b), the plurality of the discharging sections have an integrated source from which the liquid is provided.

10. The method as set forth in claim 1, further comprising the step of:
(c) sucking out the liquid from a part that is located (i) on a bottom surface of the liquid tank and (ii) closer to an inner wall facing the inner wall from which the liquid is guided into the liquid tank than to the inner wall from which the liquid is guided into the liquid tank,
in the step (b), the liquid being upwardly discharged.

11. The method as set forth in claim 1, further comprising the step of:
(d) sucking out the liquid from a part that is located (i) on an inner wall facing the inner wall from which the liquid is guided into the liquid tank and (ii) closer to a liquid surface of the liquid than to a bottom surface of the liquid tank,
in the step (b), the liquid being downwardly discharged.

12. The as set forth in claim 1, wherein
the liquid tank has an inclined bottom surface.

13. The method as set forth in claim 1, further comprising the step of:
(e) sucking out the liquid from a lower part of an inclined bottom surface of the liquid tank is inclined.

14. The method as set forth in claim 12, wherein
the inclined bottom surface is configured so that a part located toward a side from which the film is brought into the liquid tank in the step (a) is lower than another part located toward a side from which the film is taken out of the liquid tank in the step (a).

15. The method as set forth in claim 1, wherein:
in the step (a), the film being transferred in the lengthwise direction so as to pass through the liquid in a first liquid tank and in a second liquid tank; and
in the step (b),
the liquid is guided into the first liquid tank through an inner wall of the first liquid tank, which inner wall faces the widthwise end part of the film, and is then upwardly or downwardly discharged, and
the liquid is guided into the second liquid tank through an inner wall of the second liquid tank, which inner wall faces the widthwise end part of the film and is then upwardly or downwardly discharged,
the method further comprising the step of:
(f) moving the liquid from the second liquid tank to the first liquid tank.

16. A method for producing a film, comprising the steps of:
(a) transferring a film in a lengthwise direction so that the film passes through a liquid in a liquid tank; and
(b) upwardly discharging the liquid which has been guided into the liquid tank through a part of a bottom surface of the liquid tank, the part being located closer to one or the other one of two inner walls of the liquid tank, which two inner walls face respective widthwise end parts of the film.

17. A film production device, comprising:
a liquid tank;
a transferring device for transferring a film in a lengthwise direction so that the film passes through a liquid in the liquid tank; and
a discharging section for upwardly or downwardly discharging the liquid which has been guided into the liquid tank through an inner wall of the liquid tank, which inner wall faces a widthwise end part of the film.

18. A film production device, comprising:
a liquid tank;
a transferring device for transferring a film in a lengthwise direction so that the film passes through a liquid in the liquid tank; and
a discharging section for upwardly or downwardly discharging the liquid which has been guided into the liquid tank through a part of a bottom surface of the liquid tank, the part being located closer to one or the other one of two inner walls of the liquid tank, which two inner walls face respective widthwise end parts of the film.
